(19) United States
(12) Patent Application Publication
(10) Pub. No.: US 2012/0129537 A1
(43) Pub. Date: May 24, 2012

(54) Method for handoff to a femtocell in a wireless communication system, and server apparatus for the same

(75) Inventors: Guanghai Liu, Beijing (CN); Junwei Ren, Beijing (CN); Hong Wang, Beijing (CN); Tao Zhao, Beijing (CN)

(73) Assignee: Samsung Electronics Co., Ltd., Suwon-si (KR)

(21) Appl. No.: 13/373,652

(22) Filed: Nov. 23, 2011

(30) Foreign Application Priority Data
Nov. 24, 2010 (CN) 201010561125.3

(51) Int. Cl. H04W 36/30; H04W 36/08

(52) U.S. Cl. 455/444; 455/436

(57) ABSTRACT

A method handsoff a terminal to a femtocell in a wireless communication system. The method includes, upon generation of a request for handoff to the femtocell, selecting, by a second server, at least one femtocells located within a predetermined distance from a source base station as candidate femtocells for the handoff, according to a request of a first server which functions as a femtocell gateway, receiving, by the first server, a response message comprising information of the candidate femtocells from the second server, sending, by the first server, a message requesting measurement of a reverse signal strength of a terminal under the handoff to the candidate femtocells, determining, by the first server, a destination femtocell for the handoff among the candidate femtocells based on the measurement result reported from the candidate femtocells, and executing a handoff procedure to the destination femtocell from the source base station.

### CROSS-REFERENCE TO RELATED APPLICATION(S) AND CLAIM OF PRIORITY

The present application is related to and claims the benefit under 35 U.S.C. §119(a) of a Chinese Patent Application filed in the State Intellectual Property Office of the Republic of China on Nov. 24, 2010 and assigned Serial No. CN 201010561125.3, the entire disclosure of which is hereby incorporated by reference.

### TECHNICAL FIELD OF THE INVENTION

The invention relates to femtocell (e.g., super mini-type mobile base station, home base station, or the like) technologies, and more particularly, to a method for handoff to femtocell and an apparatus for the same.

### BACKGROUND OF THE INVENTION

A femtocell (femo, for short) is a mini-type 3G wireless device with low power. The femtocell may transmit voice and data call sent by a user mobile telephone to a core network on the basis of a standard interface. At present, various products which respectively support 2G, 2.5G, 3G, and 4G for the femtocell have been developed or are under development.

Various products for the femtocell which are respectively applicable for different communication standards, such as Code Division Multiple Access (CDMA), Global System For Mobile Communication (GSM), Universal Mobile Telecommunications System (UMTS), Time Division-Synchronous Code Division Multiple Access (TS-SCDMA), Long Term Evolution (LTE), Worldwide Interoperability for Microwave Access (WiMAX), etc, have also been developed or are under development.

The various products for the femtocell, which obtained high degree recognition and attention from telecom provider, possess many advantages, such as, plug-and-play (PnP), they may be deployed conveniently, and they may improve network capacity quickly.

However, the stable handoff between a macro base station of a macro cell and an access point of a femtocell (e.g., a Femtocell Access Point, (FAP), mini-type base station, or femo base station) or between FAPs have not been well solved in existing femo technologies, which has become one of bottlenecks for limiting the development and application of the femo technologies.

For example, when handoff to FAP initiated by macro base station and voice activating between FAPs in CDMA standard are taken as an example, the handoff to the FAP adopts a method for executing reverse measurement by a destination FAP.

FIG. 1 is a diagram showing a handoff procedure from an existing macro base station to an FAP.

Referring to FIG. 1, in step 101, a CDMA terminal 100 covered by a macro base station 200 receives a list of neighboring cell broadcasted by the macro base station 200. In step 103, when the terminal 100 gets close to an FAP1 500a and detects stronger pilot signal of the FAP1 500a, a PN code (that is, a pseudo-random noise sequence) transmitted through a pilot signal of the FAP1 500a is assumed to be b. In step 105, when detecting the pilot signal strength of the FAP1 500a exceeds preset threshold T_add, the terminal 100 sends a Pilot Strength Measurement Message (PSMM) to the serving macro base station 200. Herein, the PSMM message carries the pilot code of the pilot signal of a destination base station, i.e., the FAP1 500a. In step 107, the macro base station 200 sends a handoff required message notifying that handoff is required to a Mobile Switch Center (MSC) 300 to the corresponding MSC 300. The handoff required message carries Cell_ID (cell identification information) and MSC_ID (identification information of the MSC) of the destination base station, meanwhile carries Cell_ID and MSC_ID (located in serving unidirection delay field of the CDMA) of the source base station. The identification information of the terminal 100 under handoff includes Equipment Serial Number (ESN), International Mobile Subscriber Identification Number (IMSI) and public long-code mask-code identification.

In step 109, the MSC 300 sends a handoff request message to the destination Femtocell Convergence Server/Femtocell Gateway (FCS/FGW) 400 according to the MSC_ID of the destination base station through the handoff required message. In step 111, the FCS/FGW 400 issues a measure request message to all the FAPs 500a and 500b, the PN code of which is “b”, according to the value b of PN in the handoff request message. The measure request message carries the public long-code mask-code identification of the terminal 100. In step 113, all the FAPs 500a and 500b, which have received the measure request message, compute the obtained terminal long code according to the received ESN and public long-code mask-code identification, so as to execute reverse measurement for the terminal signal strength. The FAP1 500a, which has detected the initiated terminal signal for handoff request, reports the measurement result of the reverse measurement to the FCS/FGW 400. The FAP2 500b, which has not detected the initiated terminal signal for handoff request, will not report the measurement result. In step 115, the FCS/FGW 400 determines the unique destination FAP for handoff, for example, the FAP1 500a, according to the reported measurement result of the reverse measurement, transmits the handoff required message to the FAP1 500a, and to execute subsequent handoff processes.

However, in the foregoing conventional handoff procedure, when number of FAP covered by the FCS/FGW 400 is very large, each time a CDMA terminal executes handoff to an FAP from a macro base station 200, a large number of FAPs with the same PN code will execute the reverse measurement.

While two FAPs are shown in FIG. 1 for the sake of convenience, the number of FAPs actually managed by a single FCS/FGW in a network is quite large. For example, when there are 300,000 FAPs covered by one FCS/FGW and number of dedicated PN codes for the femo is 5, the FCS/FGW needs to send about 60000 measure request messages. Meanwhile, all of the 60000 FAPs which have received the message will execute the reverse measurement. Thus, the network will suffer a heavy load.

Since the small coverage and large number of the FAP, as well as the frequent interface of the FAP and the macro base station, a large number of terminals will initiate handoff request from the macro base station to the FAP simultaneously, which results in one FAP executing a large number of reverse measurement simultaneously. Thus, the handoff delay will be increased greatly, and the network performance will be reduced. While, with reference to the handoff between the FAPs, the above problems are similarly existed. Moreover, the FCS/FGW and the FAP need to use a large number of processor resources to execute the reverse measurement, and large volume processing is required. Thus, the development cost of the FCS/FGW and the FAP will be improved greatly, and the development and application size for applications of the femo technologies are limited.

### SUMMARY OF THE INVENTION

To address the above-discussed deficiencies of the prior art, it is a primary object to provide a method for efficient handoff to a femtocell in a wireless communication system, and an apparatus for the same.

The present disclosure also provides a handoff method for reducing load and delay in reverse measurement in handoff to a femtocell, and an apparatus for the same.

The present disclosure also provides a method for easily setting a range of candidate cells in handoff to a femtocell, and an apparatus for the same.

According to an aspect of the present disclosure, there is provided a method for handoff to a femtocell in a wireless communication system. The method includes, upon generation of a request for handoff to the femtocell, selecting, by a second server, at least one femtocells located within a predetermined distance from a source base station as candidate femtocells for the handoff, according to a request of a first server which functions as a femtocell gateway, receiving, by the first server, a response message comprising information of the candidate femtocells from the second server, sending, by the first server, a message requesting measurement of a reverse signal strength of a terminal under the handoff to the candidate femtocells, determining, by the first server, a destination femtocell for the handoff among the candidate femtocells based on the measurement result reported from the candidate femtocells, and executing a handoff procedure to the destination femtocell from the source base station.

According to another aspect of the present disclosure, there is provided a method for handoff to a femtocell, which is executed by a server which manages location related information of femtocells in a wireless communication system. The method includes establishing a database comprising information of other femtocell base stations located within a predetermined distance from each femtocell base station, upon receiving a request from a server which functions as a femtocell gateway according to generation of the request for the handoff to the femtocell from a source base station, querying the database and selecting at least one femtocells located within a predetermined distance from the source base station as candidate femtocells for the handoff, and providing a response message comprising the information of the candidate femtocells to the server which functions as the femtocell gateway.

According to another aspect of the present disclosure, there is provided a server apparatus for managing location related information of femtocells in a wireless communication system which supports handoff to a femtocell. The server apparatus includes at least one network interface for data communication, a database comprising information of other femtocell base stations located within a predetermined distance from each femtocell base station, and a controller for, upon receiving a request from a server which functions as a femtocell gateway according to generation of the request for the handoff to the femtocell from a source base station through the network interface, querying the database, selecting at least one femtocells located within a predetermined distance from the source base station as candidate femtocells for the handoff, and providing a response message comprising the information of the candidate femtocells to the server which functions as the femtocell gateway through the network interface.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a diagram showing a conventional handoff procedure from a macro base station to an FAP;

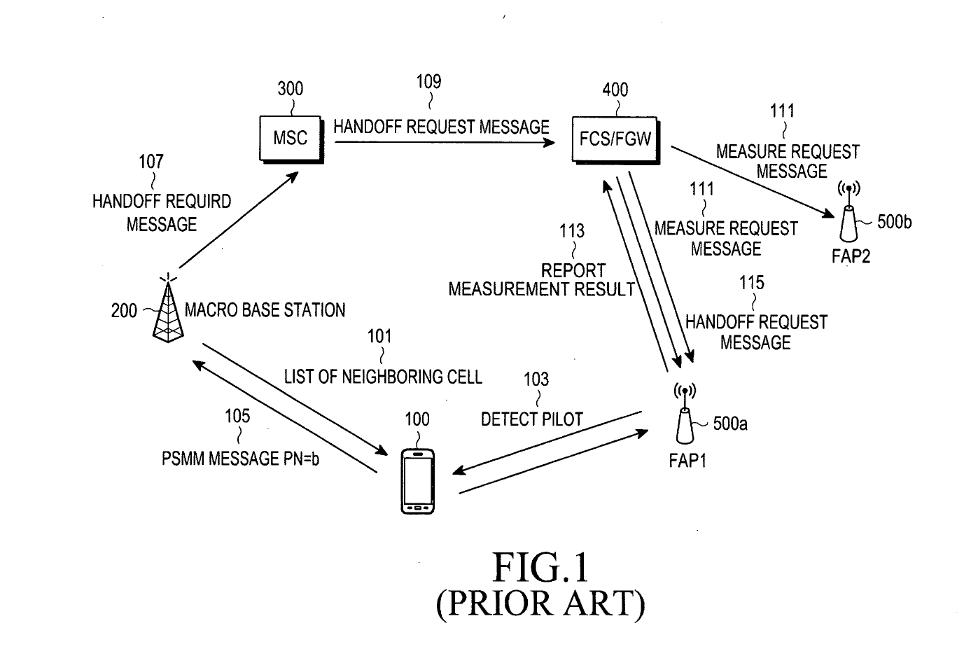

FIG. 2 illustrates a voice handoff procedure to an FAP, which is initiated by a macro base station, according to an embodiment of the present disclosure;

FIG. 3 illustrates a voice handoff procedure to another FAP, which is initiated by a source FAP, according to another embodiment of the present disclosure;

FIG. 4 illustrates a 1× voice architecture reference model of femto system on the basis of A1/A2 interface, when a location information server logical entity and an FMS are set together, according to an embodiment of the present disclosure;

FIG. 5 illustrates a 1× voice architecture reference model of femto system on the basis of A1p/A2p interface, when a location information server logical entity and an FMS are set together, according to an embodiment of the present disclosure;

FIG. 6 illustrates a 1× voice architecture reference model of femto system on the basis of A1/A2 interface, when a location information server logical entity and an FCS/FGW are set together, according to an embodiment of the present disclosure;

FIG. 7 illustrates a 1× voice architecture reference model of femto system on the basis of A1p/A2p interface, when a location information server logical entity and an FCS/FGW are set together, according to an embodiment of the present disclosure;

FIG. 8 illustrates a 1× voice architecture reference model of femto system on the basis of A1/A2 interface, when a location information server logical entity is an independent physical entity, according to an embodiment of the present disclosure; and

FIG. 9 illustrates a 1× voice architecture reference model of femto system on the basis of A1p/A2p interface, when a location information server logical entity is an independent physical entity, according to an embodiment of the present disclosure.

### DETAILED DESCRIPTION OF THE INVENTION

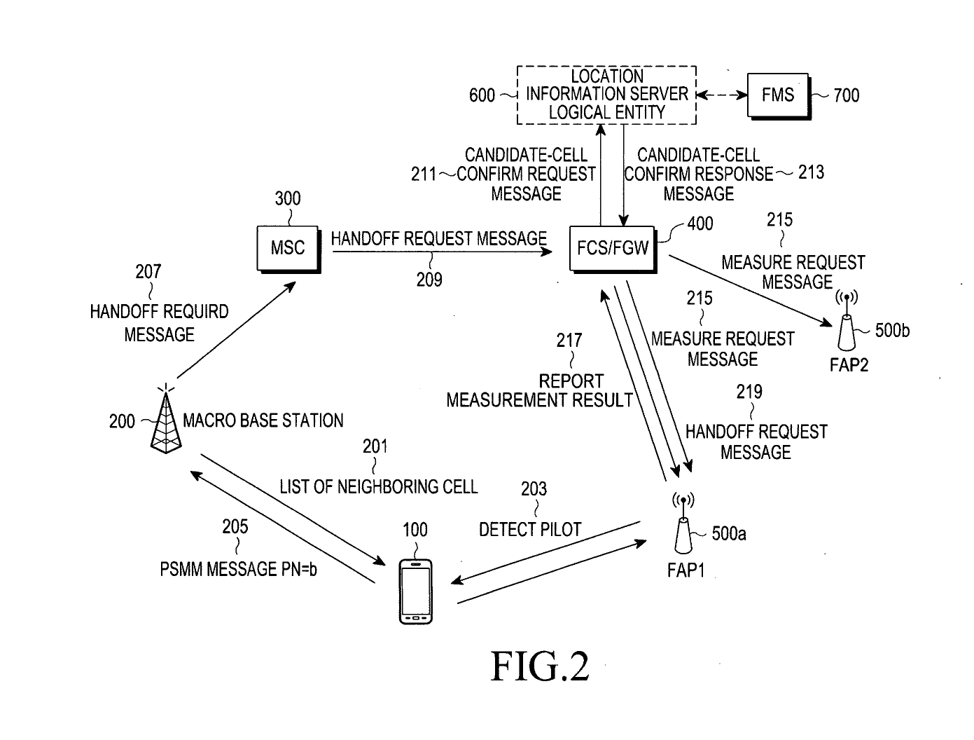

FIGS. 2 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless network. Hereinafter, exemplary embodiments of the present invention will be described in detail with reference to the accompanying drawings. The detailed descriptions of functions and configurations incorporated herein that are well known to those skilled in the art will be omitted to avoid unnecessarily obscuring the present invention.

The present disclosure proposes a method for supporting efficient handoff (also referred to as active handoff) from a source base station to a femtocell in a wireless communication system. Herein, the source base station may be a macro base station or a femto base station.

In an embodiment of the present disclosure, “(active) handoff” means that an active-state terminal under handoff switches from a particular cell covered by a macro base station to a cell of another FAP, or that the active-state terminal under handoff switches from a cell of a source FAP to a cell of another FAP.

A handoff method according to the present disclosure sets a femtocell as a destination base station to which the terminal is handed off, based on location information (longitude and latitude) of a source base station, and orders the terminal to selectively measure a channel for some femtocell. The terminal performing measurement measures a PN code of the corresponding femtocell and determines a base station of a femtocell which is handed off according to the measurement result.

Hereinafter, embodiments of the present disclosure will be described by taking voice handoff in a Code Division Multiple Access (CDMA) wireless communication system as an example for convenience' sake.

According to an embodiment of the present disclosure, conditions applicable for handoff from a source base station to a destination base station of a femtocell are given as below. The following conditions may be selectively applied to the extent that they can be modified by those of ordinary skill in the art according to implementation forms.

1. A dedicated PN code is reserved for a femtocell, the number of PN codes may be set according to the state of a current network, and the number of PN codes may be set as less than 5 generally.

2. Related information about all the macro base stations in current network, such as longitude and latitude, a PN code, a cell ID (Cell_ID), a system ID (SID), a network ID (NID), is stored in the location information server logical entity.

3. Related information about all the FAPs in current network, such as longitude and latitude, a PN code, an actual Cell_ID, an SID, an NID and a femtocell equipment ID (FEID), is stored in the location information server logical entity (in which the FEID refers to MAC_ID of an FAP, or an ID which may identify an FAP uniquely).

4. It is necessary to set the list of neighboring cells of the macro base station manually. In the macro base station, a dedicated PN code of all the femtocells may be added to the list of neighboring cell in the macro base station. Herein, the femtocell uses one or several virtual Cell_IDs. Number of the virtual Cell_IDs is smaller than or equal to the number of dedicated PNs. However, the following conditions need to be avoided. The dedicated PN code of one femtocell covered by the same FCS/FGW corresponds to different Cell_IDs. The list of neighboring cells of the macro base station will be broadcast to CDMA terminals through air interface.

Meanwhile, examples are provided as shown in Table 1, to depict the list of neighboring cell stored in the macro base station.

TABLE 1

| PN 1 of | Cell_ID 1 | SID1 | NID1 | . . . |
|---|---|---|---|---|
| macro base | | | | |
| station | | | | |
| PN 2 of | Cell_ID 2 | SID1 | NID1 | |
| macro base | | | | |
| station | | | | |
| PN 3 of | Cell_ID 3 | SID1 | NID1 | |
| macro base | | | | |
| station | | | | |
| . . . | | | | |
| Dedicated | Virtual | SIDa | NIDb | . . . |
| PN1 of FAP | Cell_ID 1 | | | |
| Dedicated | Virtual | SIDa | NIDb | |
| PN2 of FAP | Cell_ID 1 | | | |
| Dedicated | Virtual | SIDa | NIDb | |
| PN3 of FAP | Cell_ID 2 | | | |

. . .

5. Neighboring information in the list of neighboring cell in the FAP may be automatically generated by executing the following processes (1) through (4).

(1) During the starting-up process of the FAP, an automatic measurement is executed. Meanwhile, the scanned PN code, the longitude and latitude information of the FAP may be sent to a femtocell Management Server (FMS).

(2) The FMS sets parameters, such as a PN code, a Cell_ID (actual Cell_ID) for each FAP, according to predetermined rules, reports the related parameters as well as the longitude and latitude information to the location information server logical entity, to establish or update the location information database in the location information server.

(3) The FMS interacts with the location information server logical entity, sets the macro base station within a predetermined area, e.g., L1 kilometer, from the FAP as the neighbor macro base station of the FAP (L1 may be set), and sends the set information to the FAP.

When the method for selecting candidate cells for handoff to a femtocell according to an embodiment of the present disclosure is adopted, it also needs to report the neighbor relation information of these macro base stations to the location information server logical entity, so as to set and update the neighboring relation database of each FAP.

Herein, the location information server obtains the neighbor relation information between FAPs within a predetermined area (distance) from each FAP from the FMS, and sets the neighbor relation database according to the obtained neighbor relation information. Also, it needs to select FAPs within, for example, L2 kilometers from each FAP to establish the neighbor relation information of the FAP, based on the longitude and latitude of the FAP, and to update the neighboring relation database of the FAP (L2 may be set).

(4) The FMS takes all the dedicated PN codes and corresponding virtual Cell_IDs as the neighbor of the femtocell for the FAP, and sends to the FAP.

The list of neighboring cell stored by the FAP is taken as an example as shown in Table 2.

TABLE 2

| PN 1 of | Cell_ID 1 | SID1 | NID1 | . . . |
|---|---|---|---|---|
| macro base | | | | |
| station | | | | |
| PN 2 of | Cell_ID 2 | SID1 | NID1 | |
| macro base | | | | |
| station | | | | |
| PN 3 of | Cell_ID 3 | SID1 | NID1 | |
| macro base | | | | |
| station | | | | |
| . . . | | | | |
| Dedicated | Virtual | SIDa | NIDb | . . . |
| PN1 of FAP | Cell_ID 1 | | | |
| Dedicated | Virtual | SIDa | NIDb | |
| PN2 of FAP | Cell_ID 1 | | | |
| Dedicated | Virtual | SIDa | NIDb | |
| PN3 of FAP | Cell_ID 2 | | | |

. . .

6. The location information server logical entity stores location information of all the base stations in a local network. With reference to the method for selecting candidate cells for handoff to a femtocell according to an embodiment of the present disclosure, it also needs to store the neighboring relation database of the FAP.

FIG. 2 illustrates a voice handoff procedure to an FAP, which is initiated by a macro base station, according to an embodiment of the present disclosure.

Referring to FIG. 2, in step 201, a terminal 100 covered by a serving macro base station 200 receives a list of neighboring cells broadcasted by the serving macro base station 200.

In step 203, when the terminal 100 gets close to, for example, an FAP1 500a, a stronger pilot signal of the FAP1 500a than a pilot signal of the serving macro base station 200 may be detected, and a PN code of the pilot signal is assumed to be “b”.

In step 205, when detecting a strength of the pilot signal of the FAP exceeds the preset threshold T_add, the terminal 100 sends a PSMM message to the serving macro base station 200, which is a source base station. The PSMM message carries the PN code of the pilot signal of the destination base station (e.g., the FAP1 500a shown in FIG. 2).

In step 207, the serving macro base station 200 sends a handoff required message to a corresponding MSC 300. The handoff required message carries a Cell_ID (virtual Cell_ID), SID/NID of the destination base station, a Cell_ID, SID/NID (located in serving unidirection delay field of the CDMA) of the source base station, the long code information of the terminal 100 under handoff, and so on.

In step 209, the MSC 300 sends the handoff request message to a destination FCS/FGW 400, according to the destination SID/NID in the handoff required message received in step 207.

In step 211, after receiving the handoff request message from the MSC 300, the FCS/FGW 400 sends a candidate-cell confirm request message for handoff to a femtocell to the location information server logical entity 600. Herein, the location information server logical entity 600 may be provided in the location information server. The candidate-cell confirm request message carries some fields, such as the Cell_ID and SID/NID of the source base station, as well as information, such as a PN code, Cell_ID and SID/NID of the destination base station.

In step 213, after receiving the candidate-cell confirm request message, the location information server logical entity 600 may select, among a plurality of femtocells, a group of candidate cells to which handoff is to be made, according to one of the following first and second selecting methods, and may send related information to the FCS/FGW 400 in a candidate-cell confirm response message.

The first optional selecting method: after receiving the candidate-cell confirm request message, the location information server logical entity 600 queries the location information database according to the Cell_ID of the source base station (e.g., the macro base station 200), obtains the longitude and latitude of the source base station. The location information server logical entity 600 also takes the longitude and latitude information of the FAPs stored in the location information database into consideration, figures out FAPs within a predetermined area, e.g., L1 kilometer, from the base station, in which the FAPs figured out use the PN code “b”. The location information server logical entity 600 provides information, such as the actual Cell_ID, FEID and SID/NID of these FAPs, to the FCS/FGW 400. In the location information database, parameters and longitude and latitude information for each FAP are set and updated by a location information server (not shown) through report by the FMS 700.

The second optional selecting method: after receiving the candidate-cell confirm request message, the location information server logical entity 600 queries the neighboring relation database according to the Cell_ID of the source base station 200, selects all the FAPs, which have neighbor relation with the Cell_ID of the source base station 200 and use the PN codes of the destination base station (e.g., the FAP1 500a), as candidate FAPs for handoff, and provides at least one information of the selected candidate FAPs, such as the actual Cell_ID, FEID, SID and NID, to the FCS/FGW 400.

In step 215, the FCS/FGW 400 receives the candidate-cell confirm response message including at least one information of actual Cell_ID and FEID of the candidate FAPs provided by the location information server logical entity 600, and sends the measure request message to the candidate FAPs.

In step 217, the FAP (FAP1 500a shown in FIG. 2), which has received the measure request message, measures the signal strength of the terminal 100 under handoff according to the terminal long code, and reports the measurement result to the FCS/FGW 400. However, the FAP (FAP2 500b shown in FIG. 2), which has not received the signal from the terminal 100 initiated for handoff request, will not report the measurement result to the FCS/FGW 400.

In step 219, the FCS/FGW 400 determines the unique destination FAP for handoff, according to the measurement result reported by each FAP, transmits the handoff required message to the FAP 500a, and then executes subsequent handoff processes.

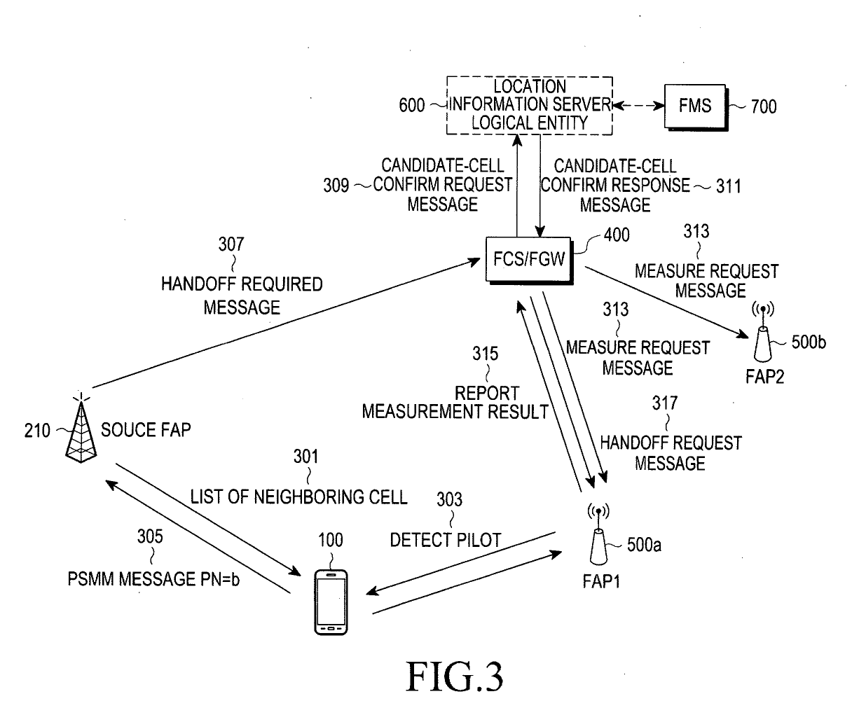

FIG. 3 illustrates a voice handoff procedure to another FAP, which is initiated by a source FAP, according to another embodiment of the present disclosure.

Referring to FIG. 3, in step 301, the terminal 100 covered by a source FAP, i.e., a serving FAP 210, receives a list of neighboring cells broadcasted by the serving FAP 210.

In step 303, when the terminal 100 gets close to, for example, one FAP 500a adjacent, the terminal 100 may detect a stronger pilot signal of the FAP 500a than the pilot signal of the serving FAP 210. Herein, the PN code of the pilot of the FAP 500a is assumed to be “b”.

In step 305, when a strength of the pilot signal of the FAP 500a detected by the terminal 100 exceeds the preset threshold T_add, the terminal 100 sends a PSMM message to the serving FAP 210. The PSMM message carries the PN code of the pilot signal of the destination base station (e.g., the FAP 500a).

In step 307, the serving FAP 210 sends a handoff required message to the FCS/FGW 313. The handoff required message includes information of the destination base station (e.g., the FAP 500a), such as the Cell_ID (virtual Cell_ID), SID/NID (FEID information may be considered to be added); Cell_ID, SID and NID (located in serving unidirection delay field of the CDMA) of the source base station (e.g., the serving FAP 210); long code information of the terminal 100 under handoff, and so on.

In step 309, after receiving the handoff required message from the serving FAP 210, the FCS/FGW 400 sends a candidate-cell confirm request message for handoff to the location information server logical entity 600. The candidate-cell confirm request message includes information, such as the Cell_ID, SID/NID (FEID information may be considered to be added) of the source base station; the PN code, Cell_ID (virtual Cell_ID), SID/NID of the destination base station, and so on.

In step 311, after receiving the candidate-cell confirm request message, the location information server logical entity 600 may select, among a plurality of femtocells, a group of candidate cells to which handoff is to be made, according to one of the following first and second selecting methods, and sends related information to the FCS/FGW 400 in the candidate-cell confirm response message.

The first optional selecting method: after receiving the candidate-cell confirm request message, the location information server logical entity 600 queries the location information database, according to the Cell_ID of the source base station (e.g., the serving FAP 210) and obtains longitude and latitude information of the source base station. Herein, if the formats of the handoff required message of step 307 and the handoff request message of step 317 include, for example, FEID information of the serving FAP 210, the location information server logical entity 600 may query the location information database according to the FEID of the serving FAP 210 instead of the Cell_ID of the serving FAP 210. The location information server logical entity 600 takes the longitude and latitude information about other FAPs stored in the database into consideration, and figures out FAPs which are within a predetermined area, e.g., L2 kilometers, from the FAP and use the PN code “b”. The location information server logical entity 600 provides information about these FAPs, such as the real Cell_ID, FEID, SID/NID to the FCS/FGW 400. Parameters and longitude and latitude information for each FAP in the location information database are set and updated by the location information server (not shown) through report by the FMS 700.

The second optional selecting method: after receiving the candidate-cell confirm request message, the location information server logical entity 600 queries the neighboring relation database in the location information server, selects all the FAPs which have neighboring relation with the source base station (the serving FAP 210) and use the PN code of the destination base station (FAP1 500a), as candidate FAPs for handoff, and provides at least one information of the Cell_ID, FEID, and SID/NID of the selected candidate FAPs, to the FCS/FGW 400.

In step 313, the FCS/FGW 400 receives the candidate-cell confirm response message including at least one information of the Cell_ID, FEID, and SID/NID of the selected candidate FAPs provided by the location information server logical entity 600, and sends a measure request message to the candidate FAPs.

In step 315, the FAP (FAP1 500a shown in FIG. 3), which has received the measure request message, measures the signal strength of the terminal 100 under handoff, according to received long code information of the terminal, and reports the measurement result to the FCS/FGW 400. However, the FAP (FAP2 500b shown in FIG. 3), which has not detected the signal from the terminal 100 initiated for handoff request, will not report the measurement report.

In step 317, the FCS/FGW 400 determines the destination FAP for handoff, according to the measurement result reported by each FAP, transmits the handoff required message to the FAP 500a, and executes subsequent handoff flow.

Moreover, it should be noted that, the method for handoff to a femtocell, which is provided by embodiments of the disclosure, may also be applied to various CDMA wireless communication systems including a High Rate Packet Data (HRPD) system.

The embodiment about the HRPD may be simply implemented by applying the following modification to the voice handoff procedure described in FIGS. 2 and 3.

When executing A16 handoff to the femto base station of the HRPD system (herein, A16 is an interface code), if the scope of candidate FAPs needing to execute the reverse measurement is reduced according to the location or neighboring relation of the source base station, there are the following differences 1 through 5 in comparison to the voice handoff procedure described with reference to FIGS. 2 and 3.

1. In the handoff message according to the embodiment shown in FIGS. 2 and 3, a cell may be identified with the Cell_ID/SID/NID. Similarly, in the A16 handoff message of the HRPD system, a cell may be identified with the packet zone ID (PZID)/SID/NID.

2. When executing the voice handoff according to the embodiment shown in FIGS. 2 and 3, cells may be searched for with the Cell_ID/SID/NID in the location information server logical entity 600. When executing the A16 handoff of the HRPD system, it is necessary to search in the location information server logical entity, according to the source FAP as well as the PZID/SID/NID and the FEID information of the destination FAP.

3. When executing the voice handoff procedure according to the embodiment shown in FIGS. 2 and 3, the PN code of the destination cell for handoff is transmitted in the PSMM message. Similarly, when executing the A16 handoff of the HRPD system, PN code information of the destination cell is transmitted in a Route Update message.

4. When executing the voice handoff according to the embodiment shown in FIGS. 2 and 3, a handoff required message is adopted at the A1/A1P interface to execute the handoff request. Similarly, when executing the A16 handoff of the HRPD system, A16: Session Transfer Request may be adopted to execute the handoff request.

5. When executing the voice handoff according to the embodiment shown in FIGS. 2 and 3, the handoff required message adopted carries PN, Cell_ID, SID/NID of the source cell/destination cell, as well as long code information of the terminal, such as the electronic serial number (ESN), international mobile subscriber identity (IMSI). Similarly, when executing the A16 handoff of the HRPD system, the message A16: Session Transfer Request carries PN, PZID, SID, NID of the source cell/destination cell, the access terminal (AT) ID, mobile node (MN) ID of the terminal, and so on.

In addition, in the method for handoff to femtocell provided by embodiments of the disclosure, the scheme for reducing the scope of candidate FAPs needing to execute reverse measurement, which is based on location or neighboring relation of the source base station, may be generalized to the process for executing the A16 handoff to the femtocell in the HRPD system.

Furthermore, while the method for handoff to the femtocell has been described based on an interoperability specification (IOS) architecture in a CDMA wireless communication system, the scheme for reducing the scope of candidate FAPs needing to execute the reverse measurement, which is based on location or neighboring relation of the source bases station, is also applicable to the CDMA femto network on the basis of IP Multimedia Subsystem (IMS) architecture.

Similarly, there are various products of the femtocell which respectively support different standards, such as CDMA, Global System for Mobile Communication (GSM), Universal Mobile Telecommunications System (UMTS), Time-Division Synchronous CDMA (TD-SCDMA), Long Term Evolution (LTE), WiMAX. Also, there are various products of the femtocell which respectively support 2G, 2.5G, 3G and 4G communication.

The method for handoff to femtocell provided by embodiments of the present disclosure may be used in CDMA standards, such as the voice active handoff, A16 handoff. The method for handoff to the femtocell according to the present disclosure may also be applied in the foregoing other standards.

Hereinafter, descriptions about the implementation scheme of the location information server, which is applicable to the method for handoff to the femtocell, provided by embodiments of the disclosure, are given as follows, in which the handoff method of 1× voice is taken as an example for convenience' sake.

First: one functional entity in a network, that is, a location information server (location information server logical entity) is newly added.

In an embodiment of the present disclosure, the location information server stores IDs of all the base stations, and corresponding location information.

Herein, the ID of the base station includes at least one of: Cell_ID (cell identification information), PZID (Packet Zone identification information), SID (System identification information), NID (Network identification information), FEID (Femtocell Equipment identification information) and so on. Alternatively, the location information server may store a neighboring relation of a femtocell and base stations within a predetermined area around the femtocell.

After receiving a handoff required message for the femtocell from the source base station or the handoff request message from the MSC, the FCS/FGW may select some femtocells from all the cells using the PN code of the destination cell as candidate cells, based on the location or neighboring relation of the source base station and inform the FCS/FGW to send the reverse measure message to the selected candidate cells only, which is different from the conventional method for handoff to the femtocell. That is, in the conventional handoff method, the FCS/FGW sends the measure request message to all cells using the PN code of the destination base station and receives the reverse measure message from all the cells, causing system load and delay in handoff. However, the handoff method according to the present disclosure receives the reverse measure message only for some femtocell based on the location or neighboring relation of the source base station, thereby significantly reducing the system load and delay.

According to another embodiment of the present disclosure, the location information server logical entity and the FMS may be implemented in a single component. Alternatively, the location information server logical entity may be implemented as an internal module of the FCS/FGW, or may be implemented as an independent physical entity.

Second: Interfaces for the location information server logical entity proposed according to an embodiment of the present disclosure are newly defined.

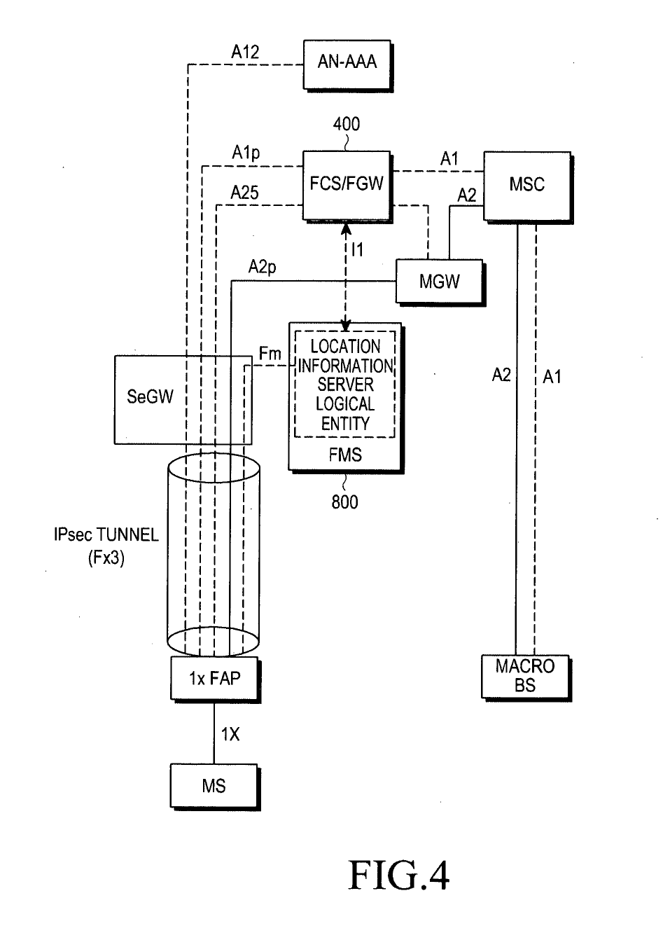

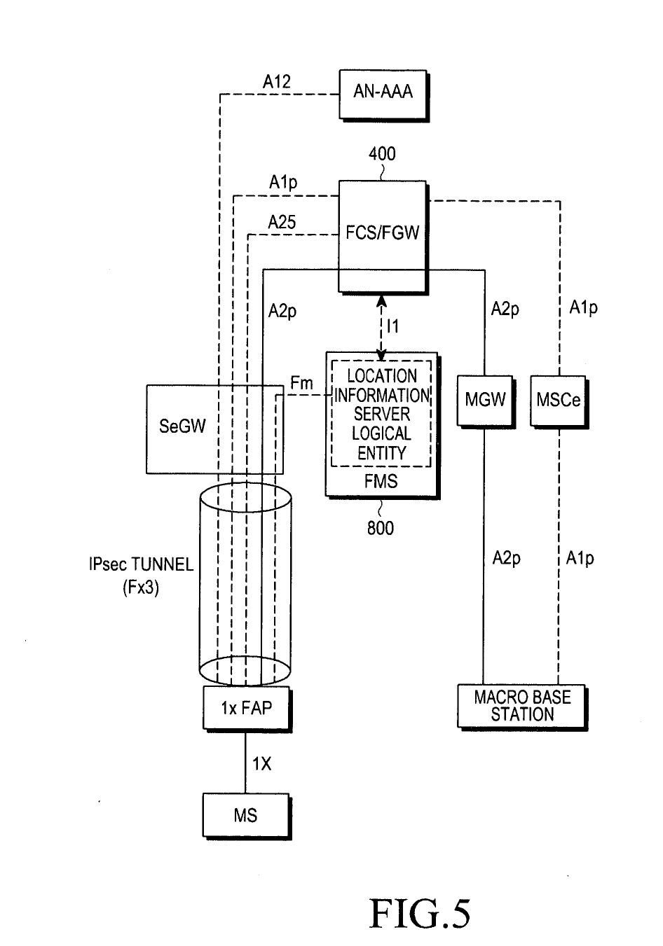

1. When the location information server logical entity is implemented together with the FMS in a single component (800 shown in FIGS. 4 and 5), a first interface (I1 shown in FIGS. 4 and 5) for communication between the FMS and the FCS/FGW is required. The first interface may use, for example, a GL interface in a standard of a CDMA 1× system.

1) The FCS/FGW may send a candidate-cell confirm request message to the location information server logical entity via the first interface. The candidate-cell confirm request message carries the following information of the source base station, such as Cell_ID (cell identification information), PZID (Packet Zone identification information), SID (System identification information), NID (Network identification information), or PDSN IP (IP address of Packet Data Serving Node), FEID (Femtocell Equipment identification information) and so on. The candidate-cell confirm request message also carries the PN code of the destination base station, and the information of the destination base station, such as the Cell_ID, PZID, SID, NID or Packet Data Serving Node (PDSN) IP.

2) The location information server logical entity may send a candidate-cell confirm response message to the FCS/FGW via the first interface. The candidate-cell confirm response message carries the actual Cell_ID (or PZID and FEID, etc) of the candidate FAP.

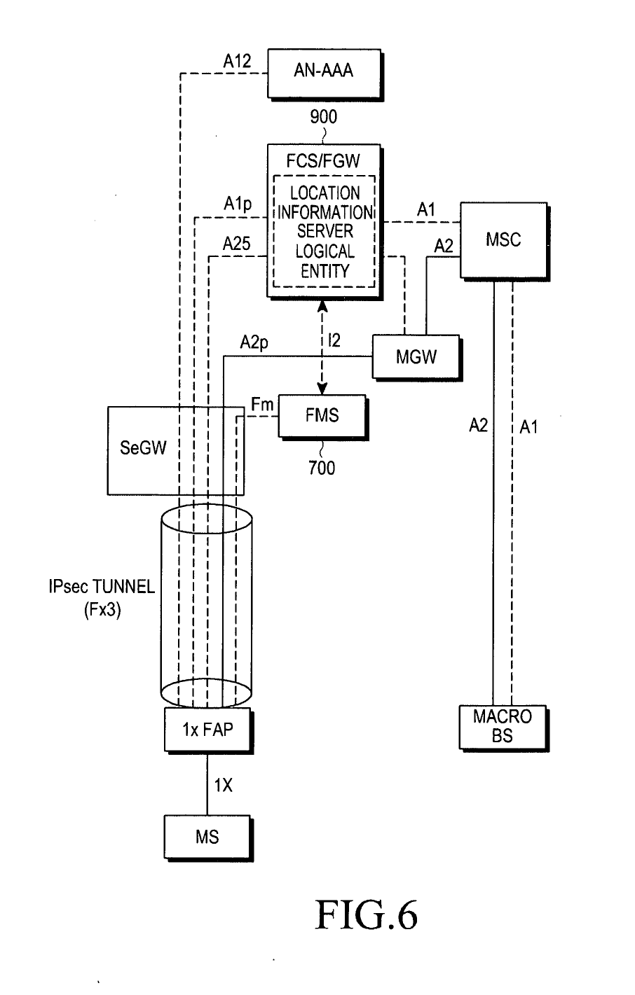

With reference to the 1× voice call, when the location information server logical entity is implemented together with the FMS in the single component 800, the location and interface of the location information server logical entity, for example, in the CDMA 1× system may be implemented as shown in FIG. 4 or 5. In FIG. 5, the MS refers to a mobile station, the macro BS refers to a macro base station, the MGW refers to a media gateway, the AN-AAA refers to a server for authentication, authorization, and accounting of the access network, the SeGW refers to a security gateway, and the IPsec tunnel (Fx3) refers to a tunnel (Fx3) of the IP security, and a detailed description of each block may refer to the well-known standard of the CDMA 1× system. This is also applied to an embodiment shown in FIGS. 6 through 9.

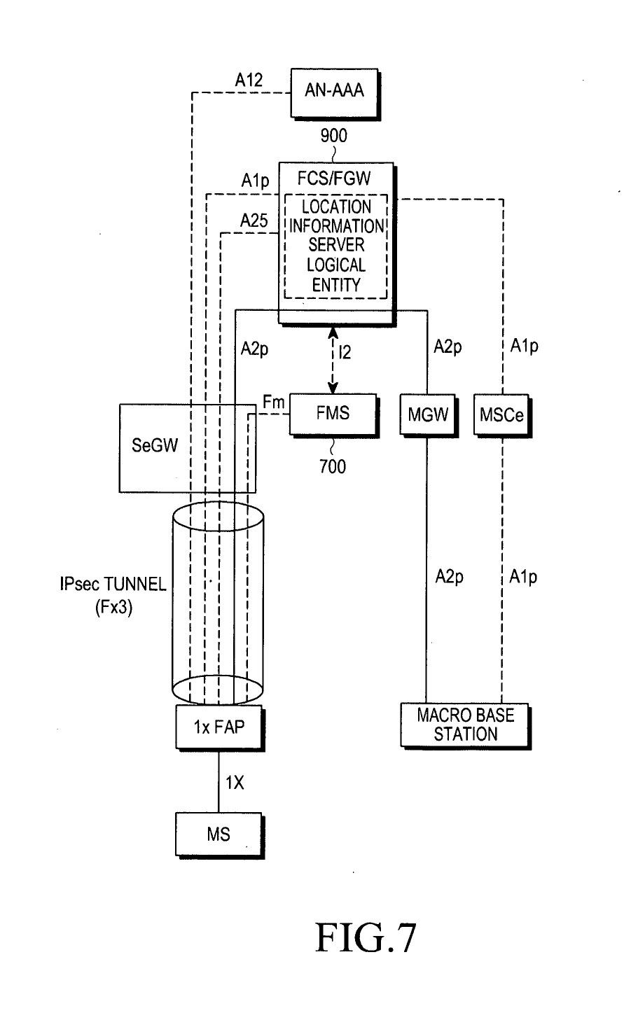

2. When the location information server logical entity is implemented as an internal module of the FCS/FGW, a second interface for communication between the FMS and the FCS/FGW is required. In FIGS. 6 and 7, reference numeral 900 refers to the FCS/FGW including the location information server logical entity as the internal module, and reference numeral 12 refers to the second interface. The second interface may use, for example, an FL interface in the standard of the CDMA 1× system.

The FMS may communicate with the location information server logical entity about the location information, wireless parameters and neighboring relation of the femtocell and the macro base station via the second interface. When adopting the configuration shown in FIGS. 6 and 7, the candidate-cell confirm request message and the candidate-cell confirm response message are implemented as internal messages between modules of the FCS/FGW.

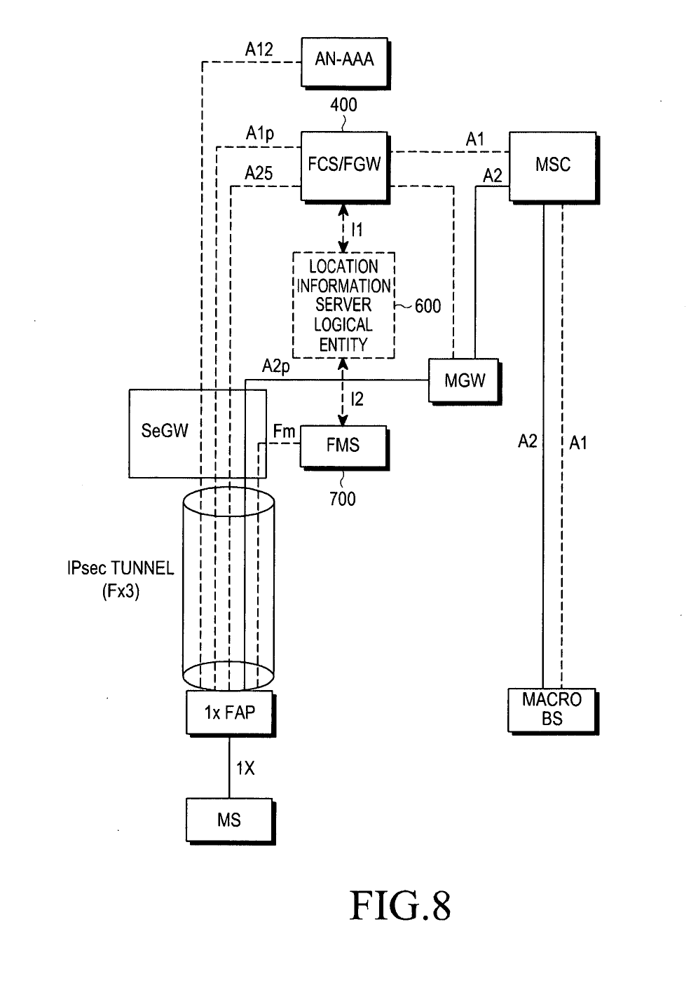

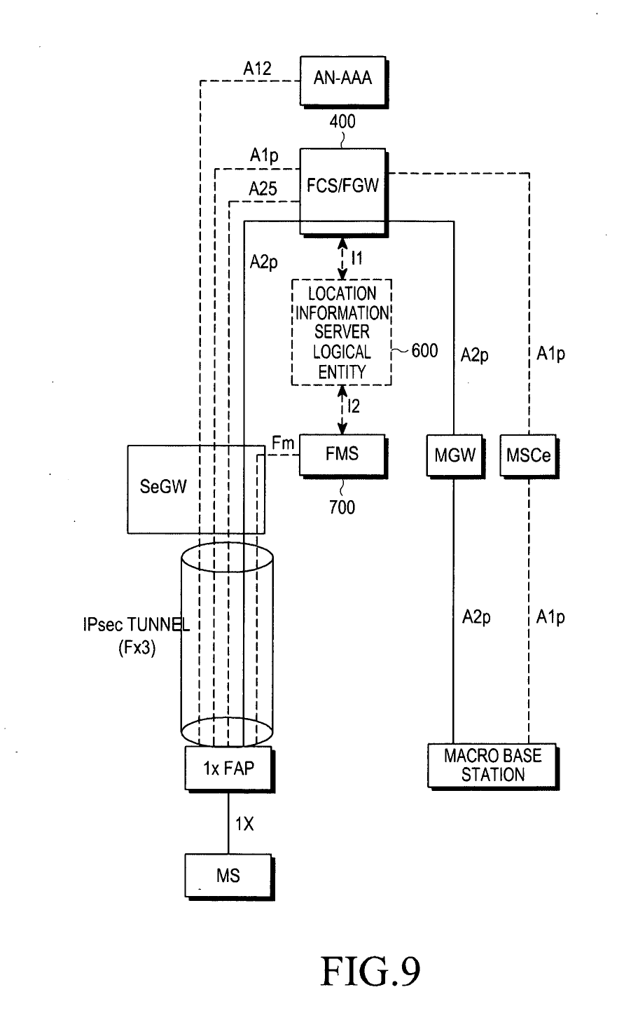

3. When the location information server logical entity is implemented as an independent physical entity, the first interface I1 for communication between the FCS/FGW 400 and the location information server logical entity 600, and the second interface I2 for communication between the location information server logical entity 600 and the FMS 700 as shown in FIGS. 8 and 9 are required. The first interface and the second interface may use, for example, a GL interface and an FL interface, respectively, in the standard of the CDMA 1× system.

Like in the description of the first interface, the FCS/FGW sends and receives the candidate cell confirm request message and the candidate cell confirm response message with the location information server logical entity through the first interface.

Like in the description of the second interface, the FMS may send and receive with the location information server logical entity about information regarding the femtocell and the macro base station, such as the location information, wireless parameters and neighboring relation through the second interface.

Third: An algorithm for selecting candidate femtocells for handoff by a location information server logical entity according to the present disclosure, to reduce the number of FAPs needing to execute the reverse measurement is as follows.

The first method for selecting candidate femtocells: the location information server logical entity queries a location information database according to the Cell_ID/PZID/SID/NID of the source base station (with reference to the source femtocell, the FEID may also be used if possible) carried in the candidate-cell confirm request message sent by the FCS/FGW, to find the longitude and latitude of the corresponding source base station. If the source base station is a macro base station, the location information server logical entity figures out all the FAPs, which are within L1 kilometers from the source macro base station and use the PN code of the destination base station and selects the corresponding FAPs as candidate FAPs for handoff. Identifications of the selected candidate FAPs (at least one identifications of the actual Cell_ID/FEID/PZID/SID/NID of the corresponding candidate FAPs, and so on) are sent to the FCS/FGW in the candidate-cell confirm response message.

If the source base station is an FAP, the location information server logical entity queries all the FAPs, which are within L2 kilometers from the source FAP and use the PN code of the destination base station and selects the corresponding FAPs as candidate FAPs. Identifications of the candidate FAPs (at least one identification of the actual Cell_ID/FEID/PZID/SID/NID of the corresponding candidate FAPs, and so on) are sent to the FCS/FGW in the candidate-cell confirm response message.

The second method for selecting candidate femtocells: the location information server logical entity queries the neighboring relation database of the FAP according to the Cell_ID/PZID/SID/NID of the source base station (with reference to the source femtocell, the FEID may also be adopted if possible) carried in the candidate-cell confirm request message sent by the FCS/FGW. As a result of the query, all the FAPs, which have neighboring relation with the source FAP and use the PN code of the destination base station and selects the corresponding FAPs as candidate FAPs. Identifications of the candidate FAPs (at least one identification of the actual Cell_ID/FEID/PZID/SID/NID of the corresponding candidate FAPs, and so on) may be sent to the FCS/FGW in the candidate-cell confirm response message.

The above parameters L1 and L2 may be set on the FMS according to practical situation. According to an embodiment of the present disclosure, these parameter values, which demonstrate the distances L1 and L2 used for searching for the candidate FAPs according to an embodiment of the present disclosure, may have direct impact on handoff success-rate and system load. Thus, it needs to consider these values compromise.

Fourth: a database needing to be established, stored and updated according to an embodiment of the present disclosure (the location information database, the neighboring relation database, and so on) is defined for the location information server logical entity.

1. A location information database of a base station (macro base station and FAP) is established, stored and updated.

The database includes information about all the base stations (including macro base station and FAP), such as longitude and latitude (location information), pilot PN, Cell_ID, PZID, SID, NID and FEID (for FAP). With reference to the macro base station, the database may further include the following information as identifying information of the macro base station optionally, such as azimuth of antenna of the base station, 3 dB vertical beam-width of antenna, antenna height, and tilt angle of the antenna.

In addition, the location information for the macro base station may be manually added. And the location information needs to be updated frequently. With reference to the FAP, the location information server logical entity may obtain information stored in the database by communicating with the FMS, so as to update the information in real time.

It should be noted that, location information and parameter information about these base stations may be taken as reference during the Self Organized Network (SON) process of the femtocell, e.g., parameter auto-planning, such as automatic PN planning, automatically adding of neighbor cell.

In an embodiment of the present disclosure, the reference format of the location information database of the base station is as follows.

Table 3 shows the reference format of the database of the macro base station.

TABLE 3

| | | | | | | | |
|---|---|---|---|---|---|---|---|
| Station name | PN | Cell_ID | PZID | SID | NID | Longitude | . . . |
| | | | | | | and | |
| | | | | | | latitude | |

Table 4 shows the reference format of the database for the FAP.

TABLE 4

| | | | | | | | | | |
|---|---|---|---|---|---|---|---|---|---|
| Station name | PN | FEID | Cell_ID | PZID | SID | NID | Longitude | Virtual Cell_ID | . . . |
| | | | | | | | and | | |
| | | | | | | | latitude | | |

2. A neighboring relation database of the FAP is established, stored and updated (only necessary when adopting the second method for selecting candidate cells).

According to the foregoing embodiment of the present disclosure, when adopting the second method for selecting candidate cells, that is, candidate cells of reverse measurement are selected by querying the neighboring relation database of the FAP, to the location information server logical entity needs to additionally establish, store and update the neighboring relation database in the location information server.

In the embodiment of the present disclosure, the method for establishing the neighboring relation database is as follows.

The location information server logical entity selects other FAPs or macro base stations within L1 kilometers from the FAP, and FAPs within L2 kilometers from the FAP, according to the location information of the FAP newly reported by the FMS and the original location information database of the base station, establishes, stores and updates a neighboring relation database which synthesizes all the FAPs (L1 and L2 here may be flexibly set to proper distances according to system conditions). The reference format of the neighboring relation database of the FAP is as shown in Table 5.

TABLE 5

| Femto | PN1 | Cell | FEID1 | PZID1 | SID1 | NID1 | macro | Cell ID 1 | PZID1 | SID1 | | NID1 |
|---|---|---|---|---|---|---|---|---|---|---|---|---|
| Station | | ID1 | | | | | base | | | | | |
| name 1 | | | | | | | station | | | | | |
| | | | | | | | PN 1 | | | | | |
| | | | | | | | macro | Cell ID 2 | PZID2 | SID1 | | NID1 |
| | | | | | | | base | | | | | |
| | | | | | | | station | | | | | |
| | | | | | | | PN 2 | | | | | |
| | | | | | | | . . . | | | | | |
| | | | | | | | FAP PN a | Cell ID a | FEID a | PZID a | SID a | NID a |
| | | | | | | | FAP PN b | Cell ID b | FEID b | PZID b | SID b | NID b |
| | | | | | | | . . . | | | | | |
| Femto | PN2 | Cell | FEID2 | PZID2 | SID1 | NID1 | macro | Cell_ID 3 | PZID3 | SID1 | | NID1 |
| Station | | ID2 | | | | | base | | | | | |
| name 2 | | | | | | | station | | | | | |
| | | | | | | | PN 3 | | | | | |
| | | | | | | | macro | Cell_ID 4 | PZID4 | SID1 | | NID1 |
| | | | | | | | base | | | | | |
| | | | | | | | station | | | | | |
| | | | | | | | PN 4 | | | | | |

| . . . | | | | | |
|---|---|---|---|---|---|
| FAP PN e | Cell_ID e | FEID e | PZID e | SID e | NID e |
| FAP PN f | Cell_ID f | FEID f | PZID f | SID f | NID f |

.

. . .

Fifth: the Mobile Management module of existed FCS/FGW may be modified as follows.

For the foregoing operations of the location information server logical entity (or the location information server) provided by embodiments of the disclosure, it is necessary to modify the Mobile Management module in existed FCS/FGW or add the following functions as below.

1. After receiving the handoff required/request message, the Mobile Management module of the FCS/FGW is able to determine whether the handoff is a handoff and handoff to a femtocell managed by the FCS/FGW. If yes, the Mobile Management module of the FCS/FGW sends a candidate-cell confirm request message to the location information server logical entity.

2. After receiving the candidate-cell confirm response message from the location information server logical entity, the Mobile Management module of the FCS/FGW may send a measure request message to these recommended femtocells, according to information about the femtocell carried in the candidate-cell confirm response message, such as Cell_ID/FEID/PZID.

According to the present disclosure, a scheme for efficient handoff to a femtocell and a location information server for the same may be provided.

On the basis of original method of reverse measurement, the method for handoff to femtocell provided by embodiments of the disclosure reduces the scope of FAP needing to execute the reverse measurement based on information of the source base station. Thus, in conventional handoff to a femtocell, when executing reverse measurement, the problems of large number of FAPs needing reverse measurement and delay and great cost associated therewith may be solved.

According to the present disclosure, a location information server logical entity may be added to the location information server, on the basis of reverse measurement solution of current 3GPP2 specification. Meanwhile, the location information server may reduce number of FAPs, which executes the reverse measurement, by using the location information of the source base station and the neighbor relation.

Moreover, algorithm of the location information server logical entity is simple, thus being implemented easily. Both load of the FCS/FGW and number of reverse measure request messages sent out may be greatly reduced, and load of the FAP generated by executing the reverse measurement may be greatly reduced.

Therefore, according to the present disclosure, the handoff to the femto from the macro cell as well as the handoff between the FAPs, which are based on the reverse measurement, may be more efficiently performed, and thus, popularization and application of the femto technologies may be improved greatly.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for handoff to a femtocell in a wireless communication system, the method comprising:
upon generation of a request for handoff to the femtocell, selecting, by a second server, at least one femtocell located within a predetermined distance from a source base station as candidate femtocells for the handoff, according to a request of a first server which functions as a femtocell gateway;
receiving, by the first server, a response message comprising information of the candidate femtocells from the second server;
sending, by the first server, a message requesting measurement of reverse signal strength of a terminal under the handoff to the candidate femtocells;
determining, by the first server, a destination femtocell for the handoff among the candidate femtocells based on a measurement result reported from the candidate femtocells; and
executing a handoff procedure to the destination femtocell from the source base station.

2. The method of claim 1, wherein the request for the handoff to the femtocell is generated when the terminal detects that a strength of a pilot signal received from an adjacent femtocell exceeds a predetermined threshold value.

3. The method of claim 1, wherein when a plurality of candidate femtocells are present, the plurality of candidate femtocells use a same pseudo noise (PN) code.

4. The method of claim 1, wherein the information of the candidate femtocells comprises at least one of a cell identification (Cell_ID), a system identification (SID), a network identification (NID), and a femtocell equipment identification (FEID) of the candidate femtocells.

5. The method of claim 1, wherein the source base station is a macro base station.

6. The method of claim 1, wherein the source base station is a femto base station.

7. The method of claim 2 further comprising:
upon generation of the request for the handoff to the femtocell, receiving, by the first server, the pseudo noise (PN) code of the pilot signal through the source base station; and
selecting, by the second server which has received the PN code from the first server, the candidate femtocells using a same code as the PN code of the pilot signal.

8. The method of claim 1 further comprising:
establishing, by the second server, a database comprising information of other femtocell base stations located within a predetermined distance from each femtocell base station.

9. The method of claim 1, wherein the second sever is implemented within the first server.

10. The method of claim 1 further comprising:
managing, by a third server which communicates with the second server, information comprising location information, identification, and a pseudo noise (PN) code of each femtocell base station, in a database.

11. The method of claim 10, wherein the second server is implemented within the first server or the third server.

12. The method of claim 10, wherein the second server is implemented independently.

13. A method for handoff to a femtocell in a wireless communication system, the method comprising:
establishing, by a server which manages location related information of femtocells in the wireless communication system, a database comprising information of other femtocell base stations located within a predetermined distance from each femtocell base station;
upon receiving a request from a server which functions as a femtocell gateway according to generation of the request for the handoff to the femtocell from a source base station, querying the database and selecting at least one femtocell located within a predetermined distance from the source base station as candidate femtocells for the handoff; and
providing a response message comprising the information of the candidate femtocells to the server which functions as the femtocell gateway.

14. The method of claim 13, wherein the request for the handoff to the femtocell is generated when the terminal detects that a strength of a pilot signal received from an adjacent femtocell exceeds a predetermined threshold value.

15. The method of claim 13, wherein when a plurality of candidate femtocells are present, the plurality of candidate femtocells use a same pseudo noise (PN) code.

16. The method of claim 13, wherein the information of the candidate femtocells comprises at least one of a cell identification (Cell_ID), a system identification (SID), a network identification (NID), and a femtocell equipment identification (FEID) of the candidate femtocells.

17. The method of claim 13, wherein the source base station is a macro base station.

18. The method of claim 13, wherein the source base station is a femto base station.

19. A server apparatus for managing location related information of femtocells in a wireless communication system which supports handoff to a femtocell, the server apparatus comprising:
at least one network interface configured for data communication;
a database configured to store information of other femtocell base stations located within a predetermined distance from each femtocell base station; and
a controller configured to, upon receiving a request from a server which functions as a femtocell gateway according to generation of the request for the handoff to the femtocell from a source base station through the network interface, query the database, select at least one femtocell located within a predetermined distance from the source base station as candidate femtocells for the handoff, and provide a response message comprising the information of the candidate femtocells to the server which functions as the femtocell gateway through the network interface.

20. The server apparatus of claim 19, wherein the request for the handoff to the femtocell is generated when the terminal detects that a strength of a pilot signal received from an adjacent femtocell exceeds a predetermined threshold value.

21. The server apparatus of claim 19, wherein when a plurality of candidate femtocells are present, the plurality of candidate femtocells use a same pseudo noise (PN) code.

22. The server apparatus of claim 19, wherein the information of the candidate femtocells comprises at least one of a cell identification (Cell_ID), a system identification (SID), a network identification (NID), and a femtocell equipment identification (FEID) of the candidate femtocells.

23. The server apparatus of claim 19, wherein the source base station is a macro base station.

24. The server apparatus of claim 19, wherein the source base station is a femto base station.
